(19) United States
(12) Patent Application Publication
(10) Pub. No.: US 2023/0328575 A1
(43) Pub. Date: Oct. 12, 2023

(54) NETWORK ACCESS REQUEST BASED ON USER EQUIPMENT CAPABILITIES

(71) Applicant: Lenovo (Singapore) Pte. Ltd., New Tech Park (SG)

(72) Inventors: Hyejung Jung, Northbrook, IL (US); Hyung-Nam Choi, Ottobrunn (DE); Ravi Kuchibhotla, Chicago, IL (US); Joachim Loehr, Wiesbaden (DE); Vijay Nangia, Woodridge, IL (US)

(21) Appl. No.: 18/024,613

(22) PCT Filed: Sep. 6, 2021
(86) PCT No.: PCT/IB2021/058111

§ 371 Date: Mar. 3, 2023

Related U.S. Application Data
(60) Provisional application No. 63/074,977, filed on Sep. 4, 2020.

(51) Int. Cl. H04W 28/02; H04W 48/08; H04W 8/24

(52) U.S. Cl. CPC H04W 28/0215; H04W 48/08; H04W 8/24

(57) ABSTRACT

In order that devices with reduced capabilities be explicitly identifiable by networks, to flexibly allow and/or restrict their access to the networks, a user equipment (UE) first determines (1102) at least one set of user equipment capabilities. The UE may determine whether an access attempt is authorized based on barring information broadcast by the network to be accessed (specifying e.g. whether a reduced capability UE is allowed to access a cell). The UE then transmits (1104) an access request message to a network device. The access request message includes information corresponding to the at least one set of user equipment capabilities.

### CROSS-REFERENCE TO RELATED APPLICATIONS

This application claims priority to U.S. Patent Application Ser. No. 63/074,977 entitled “APPARATUSES, METHODS, AND SYSTEMS FOR ACCESS CONTROL AND EARLY UE IDENTIFICATION FOR DEVICES WITH REDUCED CAPABILITIES” and filed on Sep. 4, 2020 for Hyejung Jung, which is incorporated herein by reference in its entirety.

### FIELD

The subject matter disclosed herein relates generally to wireless communications and more particularly relates to including information indicating user equipment capabilities.

### BACKGROUND

In certain wireless communications networks, network devices may not know whether user equipment devices are capable of certain communications. In such networks, the network devices may not be able to operate optimally.

### BRIEF SUMMARY

Methods for including information indicating user equipment capabilities are disclosed. Apparatuses and systems also perform the functions of the methods. One embodiment of a method includes determining, at a user equipment, at least one set of user equipment capabilities. In some embodiments, the method includes transmitting an access request message to a network device. The access request message includes information corresponding to the at least one set of user equipment capabilities.

One apparatus for including information indicating user equipment capabilities includes a user equipment. In some embodiments, the apparatus includes a processor that determines at least one set of user equipment capabilities. In various embodiments, the apparatus includes a transmitter that transmits an access request message to a network device. The access request message includes information corresponding to the at least one set of user equipment capabilities.

Another embodiment of a method for including information indicating user equipment capabilities includes receiving, at a network device, an access request message. The access request message includes information corresponding to at least one set of user equipment capabilities, and the at least one set of user equipment capabilities are based on information from a higher layer of a user equipment for triggering an access to a cell.

Another apparatus for including information indicating user equipment capabilities includes a network device. In some embodiments, the apparatus includes a receiver that receives an access request message. The access request message includes information corresponding to at least one set of user equipment capabilities, and the at least one set of user equipment capabilities are based on information from a higher layer of a user equipment for triggering an access to a cell.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for including information indicating user equipment capabilities;

FIG. 2 is a schematic block diagram illustrating one embodiment of an apparatus that may be used for including information indicating user equipment capabilities;

FIG. 3 is a schematic block diagram illustrating one embodiment of an apparatus that may be used for including information indicating user equipment capabilities;

FIG. 4 is a block diagram illustrating one embodiment of an UL-CCCH2 message;

FIG. 5 is a block diagram illustrating one embodiment of an RRCSetupRequest1 message;

FIG. 6 is a block diagram illustrating one embodiment of an RRCSetupRequest message;

FIG. 7 is a block diagram illustrating another embodiment of an RRCSetupRequest message;

FIG. 8 is a block diagram illustrating a further embodiment of an RRCSetupRequest message;

FIG. 9 is a block diagram illustrating another embodiment of an RRCSetupRequest message;

FIG. 10 is a block diagram illustrating one embodiment of a ResumeCause information element;

FIG. 11 is a flow chart diagram illustrating one embodiment of a method for including information indicating user equipment capabilities; and

FIG. 12 is a flow chart diagram illustrating another embodiment of a method for including information indicating user equipment capabilities.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

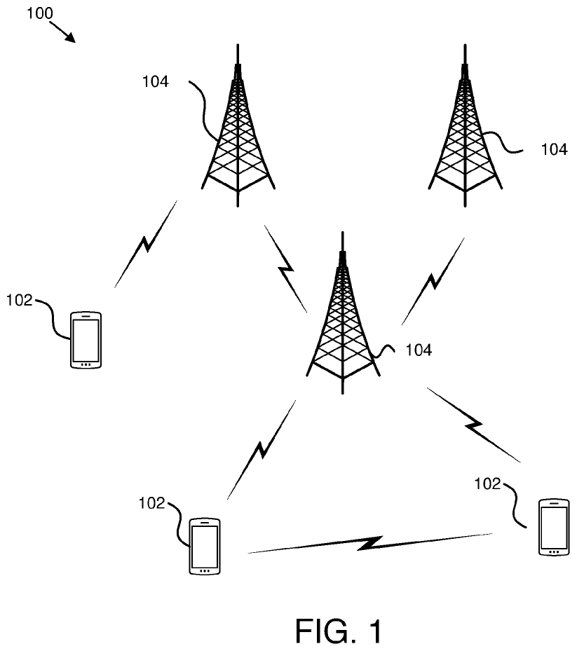

FIG. 1 depicts an embodiment of a wireless communication system 100 for including information indicating user equipment capabilities. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to and/or may include one or more of an access point, an access terminal, a base, a base station, a location server, a core network (“CN”), a radio network entity, a Node-B, an evolved node-B (“eNB”), a 5G node-B (“gNB”), a Home Node-B, a relay node, a device, a core network, an aerial server, a radio access node, an access point (“AP”), new radio (“NR”), a network entity, an access and mobility management function (“AMF”), a unified data management (“UDM”), a unified data repository (“UDR”), a UDM/UDR, a policy control function (“PCF”), a radio access network (“RAN”), a network slice selection function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in third generation partnership project (“3GPP”), wherein the network unit 104 transmits using an OFDM modulation scheme on the downlink (“DL”) and the remote units 102 transmit on the uplink (“UL”) using a single-carrier frequency division multiple access (“SC-FDMA”) scheme or an orthogonal frequency division multiplexing (“OFDM”) scheme. More generally, however, the wireless communication system 100 may implement some other open or proprietary communication protocol, for example, WiMAX, institute of electrical and electronics engineers (“IEEE”) 802.11 variants, global system for mobile communications (“GSM”), general packet radio service (“GPRS”), universal mobile telecommunications system (“UMTS”), long term evolution (“LTE”) variants, code division multiple access 2000 (“CDMA2000”), Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a remote unit 102 may determine, at a user equipment, at least one set of user equipment capabilities. In some embodiments, the remote unit 102 may transmit an access request message to a network device. The access request message includes information corresponding to the at least one set of user equipment capabilities. Accordingly, the remote unit 102 may be used for including information indicating user equipment capabilities.

In certain embodiments, a network unit 104 may receive, at a network device, an access request message. The access request message includes information corresponding to at least one set of user equipment capabilities, and the at least one set of user equipment capabilities are based on information from a higher layer of a user equipment for triggering an access to a cell. Accordingly, the network unit 104 may be used for including information indicating user equipment capabilities.

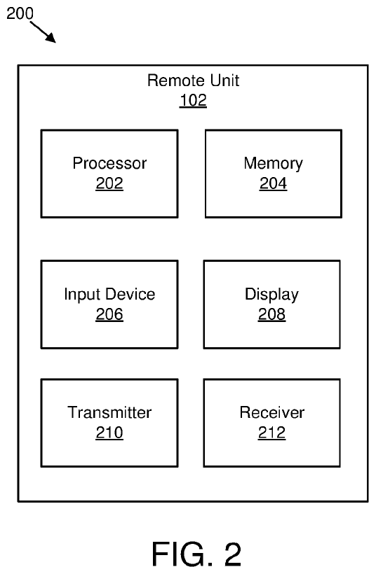

FIG. 2 depicts one embodiment of an apparatus 200 that may be used for including information indicating user equipment capabilities. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”), a light emitting diode (“LED”) display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

In certain embodiments, the processor 202 determines at least one set of user equipment capabilities. In various embodiments, the transmitter 210 transmits an access request message to a network device. The access request message includes information corresponding to the at least one set of user equipment capabilities.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

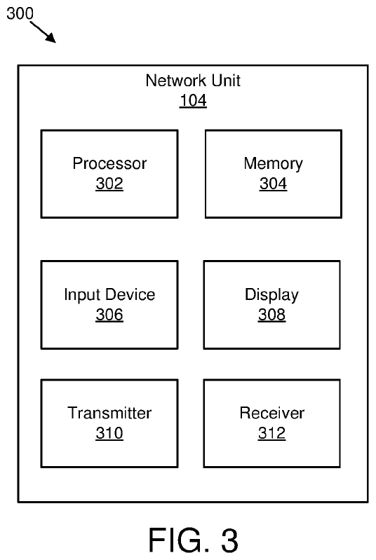

FIG. 3 depicts one embodiment of an apparatus 300 that may be used for including information indicating user equipment capabilities. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In some embodiments, the receiver 312 receives an access request message. The access request message includes information corresponding to at least one set of user equipment capabilities, and the at least one set of user equipment capabilities are based on information from a higher layer of a user equipment for triggering an access to a cell.

In certain embodiments, there may be support for reduced capability new radio devices. In such embodiments, the requirements and/or devices may have the following characteristics: 1) device complexity: motivation may be to lower the device cost and complexity as compared to high-end enhanced mobile broadband (“eMBB”) and ultra reliable low latency communication (“URLLC”) (e.g., especially for industrial sensors); 2) device size: requirement may be for a device design with compact form factor; and/or 3) deployment scenarios: system may support all frequency range 1 (“FR1”) and/or frequency range 2 (“FR2”) bands for frequency division duplexing (“FDD”) and time domain duplexing (“TDD”).

In some embodiments, there may be industrial wireless sensors. In such embodiments, a communication service availability may be 99.99% and an end-to-end latency may be less than 100 ms. Moreover, in such embodiments, the reference bit rate may be less than 2 Mbps (e.g., potentially asymmetric—for example, uplink (“UL”) heavy traffic) if the device is stationary. Furthermore, the battery may last at least a few years. For safety related sensors, a latency requirement may be lower (e.g., 5-10 ms).

In various embodiments, there may be video surveillance. In such embodiments, there may be a reference economic video bitrate of 2-4 Mbps, a latency <500 ms, a reliability 99%-99.9%. In such embodiments, there may be high-end video (e.g., for farming 7.5-25 Mbps). In such embodiments, a traffic pattern may be dominated by UL transmissions.

In certain embodiments, there may be wearables. In such embodiments, a reference bitrate for smart wearable application may be 5-50 Mbps in downlink (“DL”) and 2-5 Mbps in UL, and a peak bit rate of a device may be higher (e.g., up to 150 Mbps for downlink and up to 50 Mbps for uplink). Moreover, in such embodiments, a battery of the device may last multiple days (e.g., up to 1-2 weeks).

In some embodiments, depending on deployment and operation scenarios, it may be desirable to flexibly allow and/or restrict devices with reduced capabilities to access a particular cell (or a particular network) for efficient system operation and better coexistence with normal user equipments (“UEs”) (e.g., devices having at least a minimum set of mandatory UE capabilities). If early identification of reduced capability UEs is enabled, a new radio resource control (“RRC”) connection setup and/or resume procedure may be determined, new RRC message formats for connection setup and/or resume may be determined, and/or radio bearer and other configurations specific to reduced capability UEs may be determined. Further, a network entity may reject or allow a connection setup and/or resume request depending on active applications of reduced capability UEs and network conditions.

In various embodiments, there may be methods to make devices with reduced capabilities be explicitly identifiable to networks and flexibly allow and/or restrict their access to the networks.

In certain embodiments, such as in NR, UE capabilities of a given UE may be known to a network node (e.g., gNB); 1) by a network node retrieving UE capability information from an AMF upon receiving a UE identity (e.g., 1st part of 5G-S-TMSI in Msg3 and 2nd part of 5G-S-TMSI in Msg5 for RRC_IDLE UE, I-RNTI in Msg3 for RRC INACTIVE UE) if the UE capability information of the given UE is available in AMF; or 2) by the network node requesting and receiving UE capability information from the UE after setting up an RRC connection and enabling security, if the UE capability information of the given UE is not available in AMF.

In some embodiments, an early device identification mechanism may be detected (e.g., full UE identity transmission (e.g., 48-bit 5G-S-TMSI) in a Msg3 of a Type 1 (i.e., 4-step) random access procedure or in a MsgA PUSCH of a Type 2 (i.e., 2-step) random access procedure) and may restrict and/or allow reduced capability UEs to access to a cell and/or may enable small data transmission (e.g., early data transmission (“EDT”) (mobile originated or mobile terminated) during a random access procedure) without establishing an RRC connection with the cell.

In various embodiments, NG-RAN supports overload and access control functionality such as RACH back off, RRC connection reject, RRC connection release, and UE based access barring mechanisms.

In certain embodiments, one unified access control framework applies to all UE states (e.g., RRC_IDLE, RRC_INACTIVE, and RRC_CONNECTED) for NR. In such embodiments, NG-RAN broadcasts barring control information associated with access categories and access identities (e.g., for network sharing, the barring control information may be set individually for each PLMN). The UE may determine whether an access attempt is authorized based on the barring information broadcast for the selected PLMN, and the selected access category and access identities for the access attempt: 1) for NAS triggered requests, NAS determines the access category and access identities; 2) for AS triggered requests, RRC determines the access category while NAS determines the access identities.

In some embodiments, the gNB handles access attempts with establishment causes “emergency”, “mps-PriorityAccess”, and “mcs-PriorityAccess” (e.g., emergency calls, MPS, MCS subscribers) with high priority and responds with RRC reject to these access attempts only in extreme network load conditions that may threaten the gNB stability.

In various embodiments, unified access control does not apply to IAB-MTs.

In certain embodiments, based on operator's policy, a 5G system may be able to prevent UEs from accessing a network using relevant barring parameters that vary depending on an access identity and an access category. Access identities may be configured at the UE. Access categories may be defined by a combination of conditions related to the UE and a type of access attempt. One or more access identities and only one access category may be selected and tested for an access attempt.

In some embodiments, a 5G network may be able to broadcast barring control information (e.g., a list of barring parameters associated with an access identity and an access category) in one or more areas of the RAN.

In various embodiments, a UE may be able to determine whether or not a particular new access attempt is allowed based on barring parameters that the UE receives from broadcast barring control information and a configuration in the UE.

In certain embodiments, if multiple core networks share the same RAN, the RAN may be able to apply access control for the different core networks individually. In some embodiments, a unified access control framework may be applicable both to UEs accessing a 5G CN using E-UTRA and to UEs accessing a 5G CN using NR.

In various embodiments, a unified access control framework may be applicable to UEs in RRC Idle, RRC Inactive, and RRC Connected at a time of initiating a new access attempt (e.g., new session request). It should be noted that a “new session request” in RRC Connected may refer to events, e.g., new MMTEL voice or video session, sending of SMS (e.g., SMS over IP, or SMS over NAS), sending of IMS registration related signaling, new PDU session establishment, existing PDU session modification, and/or service request to re-establish the user plane for an existing PDU session.

In certain embodiments, a 5G system may support means by which an operator may define operator-defined access categories to be mutually exclusive. It should be noted that examples of criterion of operator-defined access categories are network slicing, application, and application server.

In some embodiments, a unified access control framework may be applicable to inbound roamers to a PLMN. In various embodiments, a serving PLMN may be able to provide a definition of operator-defined access categories to a UE.

In certain embodiments, there may be two or more predefined sets of mandatory UE capabilities to accommodate normal UEs (e.g., UEs supporting new radio (“NR”) mandatory UE capabilities with possibly capability signaling (e.g., for internet of things (“IoT”))) and reduced capability UEs. A reduced capability UE may be categorized or classified based on a set of and/or a combination of sets of mandatory UE capabilities that it supports. In one example, a first type of reduced capability UE may support a first set of mandatory UE capabilities, and a second type of reduced capability UE may support a second set of mandatory UE capabilities. In another example, a reduced capability UE may be a first type of reduced capability UE at a first time instance and a second type of reduced capability UE at a second time instance. In a further example, a reduced capability UE may indicate to the network its capability of a first type of reduced capability and a second type of reduced capability.

In some embodiments, a UE includes a full UE identity and/or an indication of a UE category (or a UE class) in an extended or modified RRC setup request message. Each UE category (or UE class) may define particular sets of mandatory UE features and/or capabilities. If the UE has been registered to a network and the full UE identity is included in the RRC setup request message, a network node (e.g., gNB) may further retrieve UE-specific capability information from the network (e.g., AMF) based on the received full UE identity. Upon receiving the indication of the UE class or the UE category, a gNB may immediately identify the set of UE features and/or capabilities without communicating with the core network.

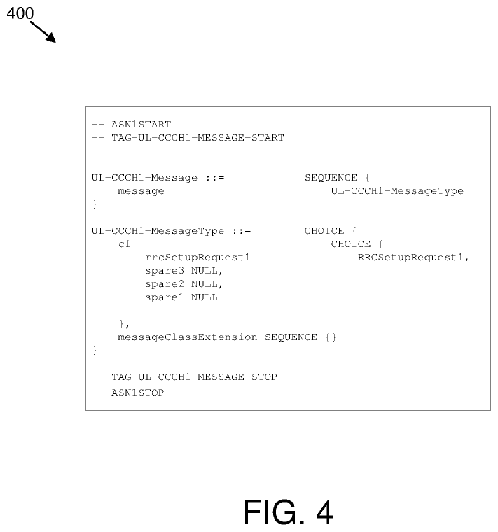

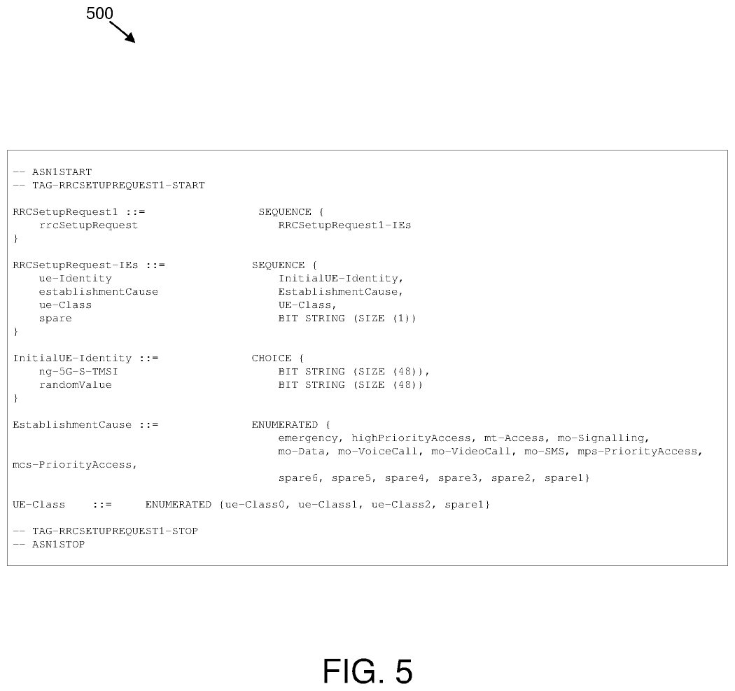

In various embodiments, a new UL common control channel (“CCCH”) 2 (“UL-CCCH2”) message (e.g., have 56-bits and may include a ‘RRCSetupRequest1’ message (for example, an extended RRC setup request message) that includes a parameter ‘tie-Class’ as shown in FIGS. 4 and 5). In one example, the parameter ‘tie-Class’ may indicate a combination of sets of mandatory UE features and/or capabilities that a UE supports. The combination of sets of mandatory UE features and/or capabilities includes one or more sets of mandatory UE features and/or capabilities. The new UL-CCCH2 may be identified by a separate logical channel identity (“LCID”) value different than LCID values of UL CCCH (“UL-CCCH”) and CCCH 1 (“CCCH1”). A reduced capability UE may use the new UL-CCCH2 if one or more conditions are met (e.g., if it is not operated in coverage enhancement mode and/or if Msg3 or MsgA repetition is enabled) (i.e., a physical uplink shared channel (“PUSCH”) aggregation factor or a number of PUSCH repetitions is larger than one). In another example, a UE initially attempting to access a network (e.g., UE has not ever performed registration in a fifth generation (“5G”) NR system before and thus has not been assigned with a unique identifier (e.g., 5G globally unique temporary identifier (“GUTI”) (“5G-GUTI”) and/or 5G serving (“S”) temporary mobile subscriber identity (“TMSI”) (“5G-S-TMSI”)) from the 5G NR system) may not use or be allowed to use the UL-CCCH2 message and may instead use the UL-CCCH message for an RRC setup request. In this example, the randomValue for the InitialUE-Identity may no longer be needed, thus reducing the size of the UL-CCCH2 message by 1-bit. The size of the UL-CCCH2 message may be reduced by up to 2 bits by eliminating some of the spare values for identifying the uplink CCCH message type.

FIG. 4 is a block diagram illustrating one embodiment of an UL-CCCH2 message 400 (e.g., 56-bits RRC message). Moreover, FIG. 5 is a block diagram illustrating one embodiment of an RRCSetupRequest1 message 500.

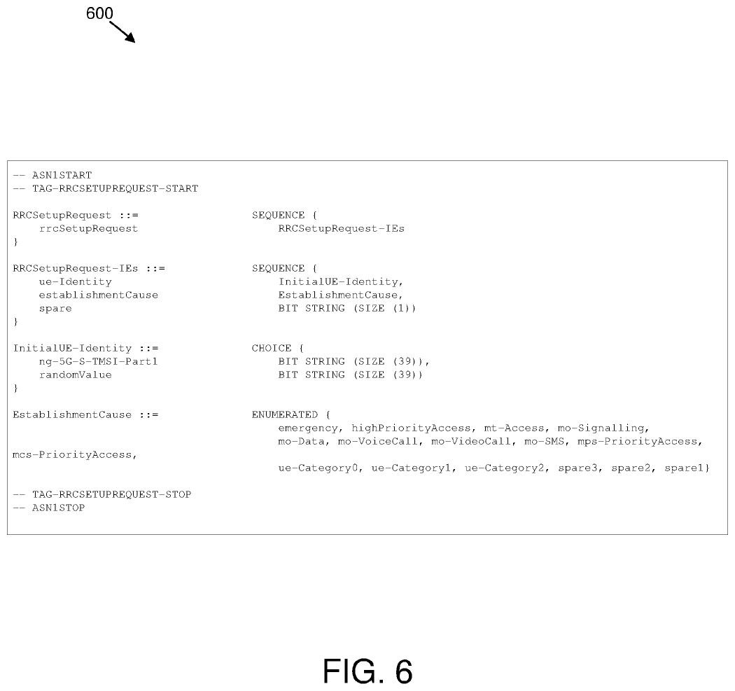

In some embodiments, a reduced capability UE provides information of a UE category by using a spare value of the parameter ‘EstablishmentCause’ in the RRCSetupRequest message of 48 bits, as shown in FIG. 6. In one example, the parameter values ‘ue-Category0’, ‘ue-Category1’, and ‘ue-Category2’ may indicate a first, second, and third set of mandatory UE features and/or capabilities, respectively. The reduced capability UE may determine the UE category value to be included in the RRCSetupRequest message, depending on which service triggers an access attempt. Further, each UE category value may be associated with one or more access categories. The one or more access categories may be defined specifically for reduced capability UEs. In certain configurations, the one or more access categories defined for normal UEs (e.g., NR UEs) may be used for reduced capability UEs.

In various embodiments, a UE indicates itself as a reduced capability UE by using a spare bit (e.g., 1 bit) in the ‘RRCSetupRequest-IEs’ and may additionally select the ‘EstablishmentCause’ parameter value according to definitions of parameter values and their mapping to codepoints defined for reduced capability UE. For example, reduced capability UEs may set the spare bit to be ‘ 1’ while normal UEs (e.g., UEs supporting mandatory capabilities of NR UEs) set the spare bit to be ‘0’.

As illustrated, FIG. 6 is a block diagram illustrating one embodiment of an RRCSetupRequest message 600.

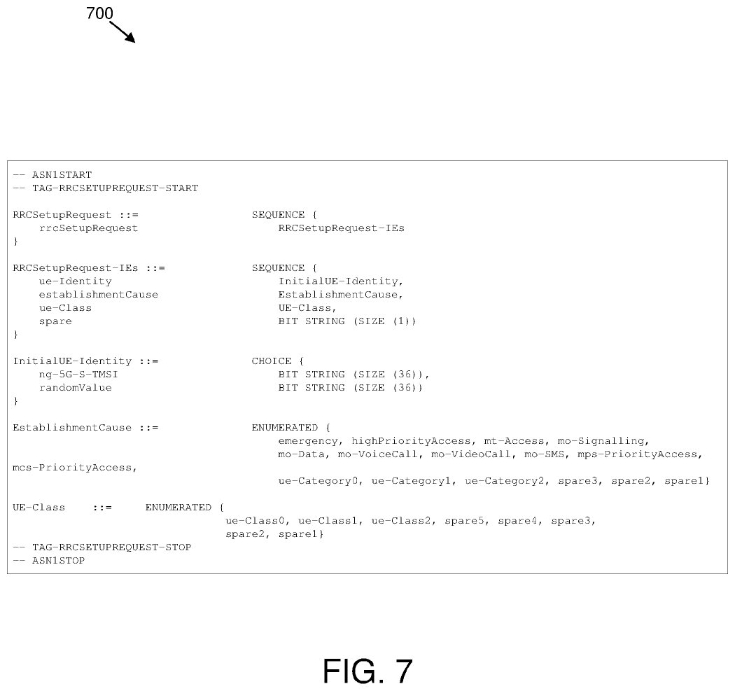

In certain embodiments, a UE includes a parameter ‘tie-Class’ to indicate a combination of sets of mandatory UE features and/or capabilities that the UE supports and an indication of a UE category in the parameter ‘EstablishmentCause’ to indicate a set of UE features and/or capabilities associated with a triggered service in a modified RRC setup request message (e.g., ‘RRCSetupRequest’), as shown in FIG. 7. Specifically, FIG. 7 is a block diagram illustrating another embodiment of an RRCSetupRequest message 700. In FIG. 7, the UE transmits the rightmost 36 bits of 5G-S-TMSI instead of the rightmost 39 bits of 5G-S-TMSI and uses the remaining 3 bits to indicate the UE class. A gNB may determine how to interpret the received 39 bits (e.g., either according to an NR definition of the ‘RRCSetupRequest’ message or according to a modified definition of the ‘RRCSetupRequest’ message) based on an indicated selection of ‘EstablishmentCause’. That is, if a spare value of ‘EstablishmentCause’ in NR is indicated, the gNB may determine that the received RRC message is interpreted according to a modified definition of the ‘RRCSetupReques’ message.

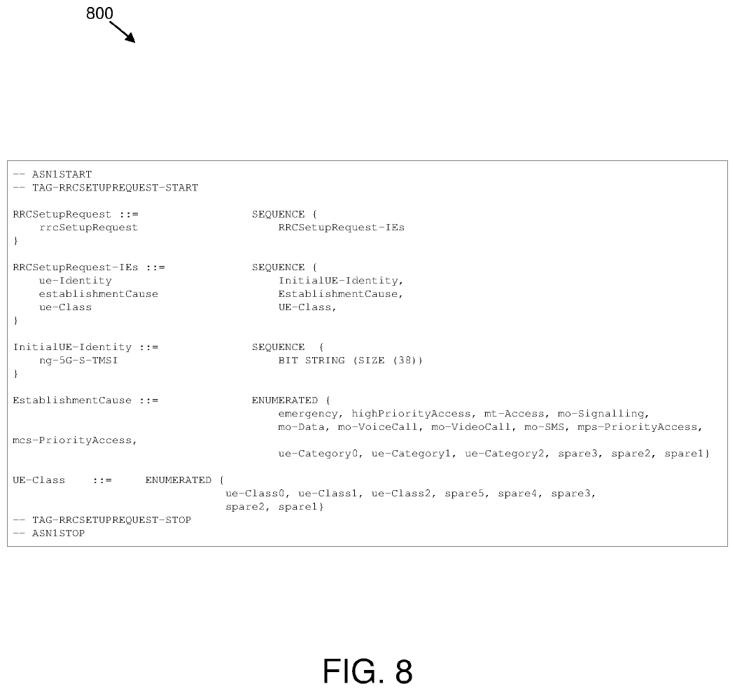

In some embodiments, a UE initially attempting to access a network (e.g., UE has not ever performed registration in a 5G NR system before and thus not been assigned with a unique identifier (e.g., 5G-GUTI and/or 5G-S-TMSI) from the 5G NR system) may not use or be allowed to use a modified RRC setup request message and may instead use the legacy and/or unmodified RRC setup request message for an RRC setup request. In such embodiments, a choice of a randomValue for an InitialUE-Identity may not be needed (e.g., 1-bit). Accordingly, because of this unused 1 bit and the spare 1-bit, the rightmost 38 bits of 5G-S-TMSI may be indicated in a modified RRC setup request message by a UE with assigned 5G-S-TMSI, as shown in FIG. 8. Specifically, FIG. 8 is a block diagram illustrating a further embodiment of an RRCSetupRequest message 800. The 38 bits of 5G-S-TMSI may correspond to a 6-bit access and mobility management function (“AMF”) pointer+32-bit 5G-TMSI.

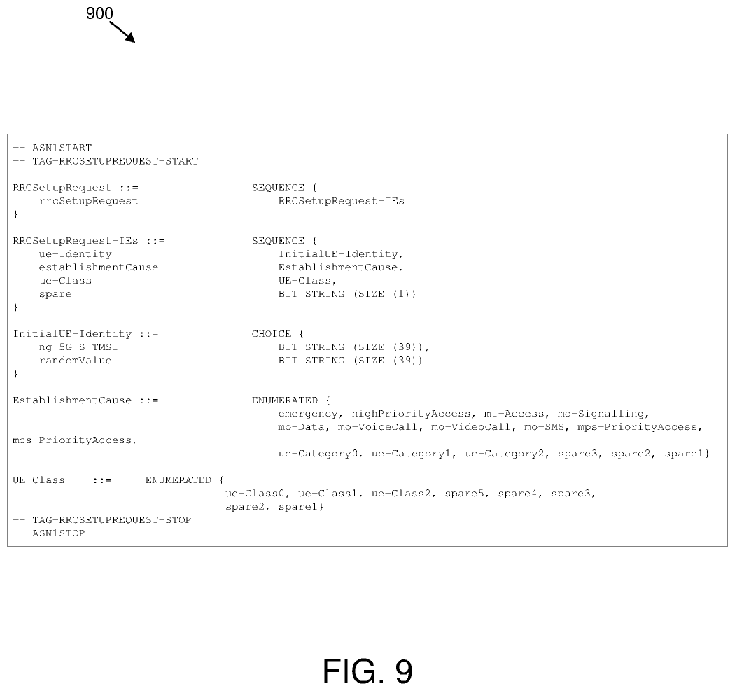

In another example, a modified RRCSetupRequest message size is 48 bits (e.g., the same as the size of UL-CCCH message), as shown in FIG. 9. Specifically, FIG. 9 is a block diagram illustrating another embodiment of an RRCSetupRequest message 900.

In various embodiments, a UE includes an indication of a UE category (e.g., a particular set of mandatory UE features and/or capabilities associated with a service type triggering a resume attempt (and/or associated with one or more access categories)) in an RRC resume request message. A network node may determine which UE features and/or capabilities are applicable to the UE after establishing an active session based on the received indication of the UE category. For example, if a triggering application of a wearable device is related to a small packet traffic (e.g., ‘heartbeat’ traffic of 100 byte packet size with 1 second mean inter-arrival time), the UE may be configured with a part of capability it may support (e.g., single-layer multiple input multiple output (“MIMO”) only, active with 1 receive antenna even though it supports operation with 2 receive antennas) based on the indication of the UE category.

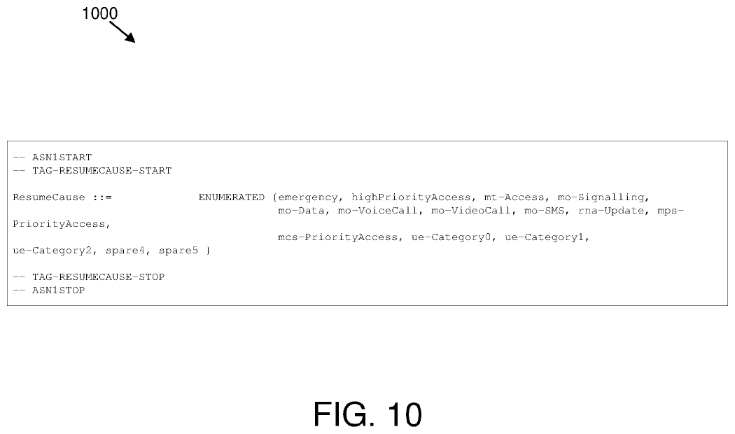

In certain embodiments, an indication of a UE category may be included in a parameter ‘ResumeCause’ as shown in FIG. 10. Specifically, FIG. 10 is a block diagram illustrating one embodiment of a ResumeCause information element 1000.

In some embodiments, a cell potentially serving reduced capability UEs may configure a bandwidth of a control resource set (“CORESET”) with an index of zero (e.g., CORESET0, a CORESET for an associated type 0 physical downlink control channel (“PDCCH”) (“Type0-PDCCH”) common search space (“CSS”) for a downlink control information (“DCI”) format with a cyclic redundancy check (“CRC”) scrambled by a system information (“SI”) radio network temporary identifier (“RNTI”) (“SI-RNTI”) on the primary cell of a master cell group (“MCG”)) to be equal to or less than a minimum UE bandwidth of reduced capability UEs for a given frequency band (e.g., a smallest UE bandwidth that is supported on a given frequency band for UEs that are permitted to camp and/or not barred on a cell in the given frequency band). That is, reduced capability UEs do not expect that a bandwidth of CORESET0 is larger than a predefined minimum UE bandwidth for them. In such embodiments, the same CORESET0 may be used for normal UEs and reduced capability UEs. In one example, an indication of cell barring (e.g., not allowing a UE to camp on a cell) for reduced capability UEs is included in a first system information block (“SIB”) (“SIB1”) or a PDCCH that schedules a physical downlink shared channel (“PDCCH”) carrying SIB1.

In various embodiments, a cell serving at least certain types and/or categories of reduced capability UEs in addition to normal UEs (e.g., UEs supporting NR mandatory UE features and/or capabilities) may configure a bandwidth of a CORESET0 larger than a UE bandwidth of a reduced capability UE. In one example, the reduced capability UE considers that accessing the cell with the CORESET0 bandwidth larger than the UE bandwidth is barred for the reduced capability UE. That is, access barring or access allowance is implicitly indicated at least based on the CORESET0 bandwidth configuration. In another example, to support more flexible and diverse deployment scenarios, a reduced capability UE is still allowed to access the cell. To enable this, the reduced capability UE performs its reception of CORESET0 in two stages (e.g., receiving a first subset of resource blocks (“RBs”) of the CORESET0 in a first monitoring occasion and receiving a second subset of RBs of the CORESET0 in a second monitoring occasion), and combines them to decode a candidate PDCCH. In such embodiments, it may be assumed that a network entity may not change a PDCCH candidate of an actual PDCCH transmission across the first and second monitoring occasions.

In certain embodiments, a reduced capability UE may initiate identifying configuration information of a separate CORESET0 and a corresponding separate Type0-PDCCH CSS intended for the reduced capability UE once determining that the bandwidth of the legacy (e.g. NR) CORESET0 of the legacy Type0-PDCCH CSS set configured by pdcch-ConfigSIB1 in a master information block (“MIB”), by searchSpaceSIB1 in PDCCH-ConfigCommon, or by searchSpaceZero in PDCCH-ConfigCommon being wider than the UE bandwidth of the reduced capability UE for a given frequency band. In such embodiments, the cell provides the separate CORESET0 of the separate Type0-PDCCH CSS for the reduced capability UE. The reduced capability UE may identify a configuration of the separate CORESET0 and the separate Type0-PDCCH CSS: 1) from a separate physical broadcast channel (“PBCH”) intended to the reduced capability UE; 2) from different interpretation of a particular bit field of MIB and/or PBCH intended for both the normal UEs and the reduced capability UE; and/or 3) based on configuration of the legacy CORESET0 and Type0-PDCCH CSS (e.g., by applying a predefined time (e.g., symbol and/or slot) and/or frequency (e.g., subcarrier) offset and/or a bandwidth scaling factor). If a separate PBCH intended to the reduced capability UE is transmitted, a time and frequency resource of the separate PBCH may be determined with respect to a time and/or frequency resource of the legacy PBCH (e.g., based on a predefined time and/or frequency offset).

In some embodiments, a CORESET0, a searchSpaceZero (or searchSpaceSIB1), fallback DCI formats (e.g., DCI formats 0_0/1_0) used for system information delivery, Msg2, Msg3, and/or Msg4 of a random access procedure, and paging DCI, SI-RNTI (e.g., RNTI used for SI delivery), paging (“P”) RNTI (“P-RNTI”) (e.g., RNTI used for paging DCI), and/or a system information message (e.g., SIBx) for reduced capability UEs may be separately defined and/or configured from those defined and/or configured for normal UEs. Further, a physical random access channel (“PRACH”) configuration (e.g., including a PRACH format—configuration of RACH occasions) and/or a RACH configuration (e.g., including a maximum number of preamble transmissions—a preamble power ramping step) for the reduced capability UEs may be separately configured from those defined and/or configured for the normal UEs.

In certain embodiments, a network entity includes access barring information (e.g., temporary access restriction information) for reduced capability UEs as a short message in paging DCI (e.g., using a short message field in DCI format 1_0 in PDCCH with CRC scrambled by P-RNTI). Since the access barring information for the reduced capability UEs is indicated in the paging DCI, a reduced capability UE that has camped on a cell does not have to decode PDCCH (e.g., with CRC scrambled with SI-RNTI) and PDSCH related to SIB1 delivery to check whether access is allowed or not. Upon receiving the short message of paging DCI, the reduced capability UE may identify whether access to the cell is allowed.

Tables 1 and 2 provide example definitions of short messages. In these tables, bit 1 is the most significant bit. Moreover, in Table 1, access barring information is indicated per public land mobile network (“PLMN”) group (e.g., a subset of PLMNs associated with a cell). In Table 2, access barring information is indicated per reduced capability UE class and/or type (e.g., a combination of sets of mandatory UE capabilities). In other examples, the short message field may be extended. Further, access barring information may be indicated per PLMN group per UE class and/or type. A network entity may include information of one or more PLMN groups for a cell in SIB1.

TABLE 1
Short Messages

| Bit | Short Message |
|---|---|
| 1 | systemInfoModification |
| | If set to 1: indication of a BCCH modification other than SIB6, SIB7 |
| | and SIB8. |
| 2 | etwsAndCmasIndication |
| | If set to 1: indication of an ETWS primary notification and/or an |
| | ETWS secondary notification and/or a CMAS notification. |
| 3 | stopPagingMonitoring |
| | If set to 1: stop monitoring PDCCH occasions(s) for paging in this |
| | PO. |
| 4 | accessBarringIndication1 |
| | If set to 1, access of reduced capability UEs to a cell with PLMN |
| | group1 is barred. |
| 5 | accessBarringIndication2 |
| | If set to 1, access of reduced capability UEs to a cell with PLMN |
| | group2 is barred. |
| 6-8 | Not used in this release of the specification, and shall be ignored by |
| | UE if received. |

TABLE 2
Short Messages

| Bit | Short Message |
|---|---|
| 1 | systemInfoModification |
| | If set to 1: indication of a BCCH modification other than SIB6, SIB7 |
| | and SIB8. |
| 2 | etwsAndCmasIndication |
| | If set to 1: indication of an ETWS primary notification and/or an |
| | ETWS secondary notification and/or a CMAS notification. |
| 3 | stopPagingMonitoring |
| | If set to 1: stop monitoring PDCCH occasions(s) for paging in this |
| | PO. |
| 4 | accessBarringIndication1 |
| | If set to 1, access of Class 1 reduced capability UEs to a cell is |
| | barred. |
| 5 | accessBarringIndication2 |
| | If set to 1, access of Class 2 reduced capability UEs to a cell is |
| | barred. |
| 6-8 | Not used in this release of the specification, and shall be ignored by |
| | UE if received. |

In some embodiments, different SI-RNTIs (e.g., each SI-RNTI specific to a particular UE type or a UE class and/or category) may be predefined (e.g., a first SI-RNTI for normal UEs (e.g., UEs supporting NR mandatory UE features and/or capabilities), a second SI-RNTI for a type 1 reduced capability UE, and a third SI-RNTI for a type 2 reduced capability UE).

In various embodiments, different SIB1 s (e.g., each SIB1 specific to a UE type, class, and/or category) may be defined and transmitted in separate PDSCHs (e.g., each PDSCH scheduled by a separate PDCCH with CRC scrambled with an associated SI-RNTI). For example, cell selection parameters and ‘UE-TimersAndConstants’ containing timers and constants used by the UE are separately configured and indicated in separate SIB1 PDSCHs.

In some embodiments, PDSCHs carrying SIB1 s for different UE types, classes, and/or categories may be the same or different depending on network operation. If PDSCH carrying SIB1s is the same for all UE types, classes, and/or categories, different PDCCHs with CRC scrambled with different SI-RNTIs may schedule the same SIB1 PDSCH.

In some embodiments, all UEs support the same set of mandatory UE capabilities, and a UE may indicate whether to support for optional capabilities in a UE capability information message upon receiving a UE capability enquiry message from a network.

In another embodiment, two or more predefined sets of mandatory UE capabilities are specified, and a reduced capability UE may indicate a set of and/or a combination of sets of mandatory UE capabilities that it supports. A UE may include an indication of a UE class (e.g., a predefined combination of sets of UE capabilities that a UE supports) and/or an indication of a UE category (e.g., a predefined set of UE capabilities associated with a particular access triggering cause) in an earliest RRC message during RRC connection setup and/or RRC connection resume procedure.

In various embodiments, such as beyond LTE-Advanced network, Category0 UE's access to a cell may be controlled by setting a respective flag (e.g., “category0Allowed” in SIB1). Further, direct indication information, such as systemInfoModification, eab-ParamModification, uac-ParamModification, may be transmitted on machine type communication PDCCH (“MPDCCH”) using P-RNTI. However, with these methods, a UE that has already camped on a cell may have to decode PDCCH and/or PDSCH related to SIB1 delivery to identify access barring information. In an embodiment, a UE that has camped on a cell identifies whether access to a cell is allowed upon receiving a short message of paging DCI.

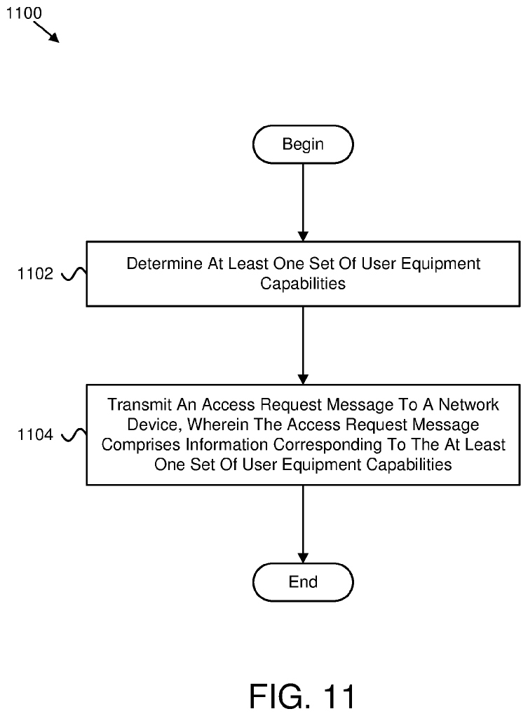

FIG. 11 is a flow chart diagram illustrating one embodiment of a method 1100 for including information indicating user equipment capabilities. In some embodiments, the method 1100 is performed by an apparatus, such as the remote unit 102. In certain embodiments, the method 1100 may be performed by a processor executing program code, for example, a microcontroller, a microprocessor, a CPU, a GPU, an auxiliary processing unit, a FPGA, or the like.

In various embodiments, the method 1100 includes determining 1102, at a user equipment, at least one set of user equipment capabilities. In some embodiments, the method 1100 includes transmitting 1104 an access request message to a network device. The access request message includes information corresponding to the at least one set of user equipment capabilities.

In certain embodiments, the access request message further comprises information corresponding to a plurality of sets of user equipment capabilities supported by the user equipment. In some embodiments, the method 1100 further comprises receiving a configuration for subsequent communications, wherein the configuration is based on the information corresponding to the at least one set of user equipment capabilities. In various embodiments, the configuration comprises a radio bearer configuration, a physical layer parameter configuration, or a combination thereof.

In one embodiment, the method 1100 further comprises receiving information from a higher layer of the user equipment for triggering an access to a cell, wherein determining the at least one set of user equipment capabilities comprises determining the at least one set of user equipment capabilities based on the received information from the higher layer. In certain embodiments, the access request message further comprises information of a full user equipment identity of the user equipment. In some embodiments, the method 1100 further comprises: receiving access barring information via a broadcast channel; and determining whether access to a cell is restricted based on the access barring information; wherein transmitting the access request message comprises transmitting the access request message in response to determining that the access to the cell is not restricted.

In various embodiments, the access barring information comprises a plurality of access barring information, and each of the plurality of access barring information corresponds to a user equipment type. In one embodiment, the access request message further comprises information of a user equipment type of the user equipment. In certain embodiments, the user equipment comprises a device with a reduced capability.

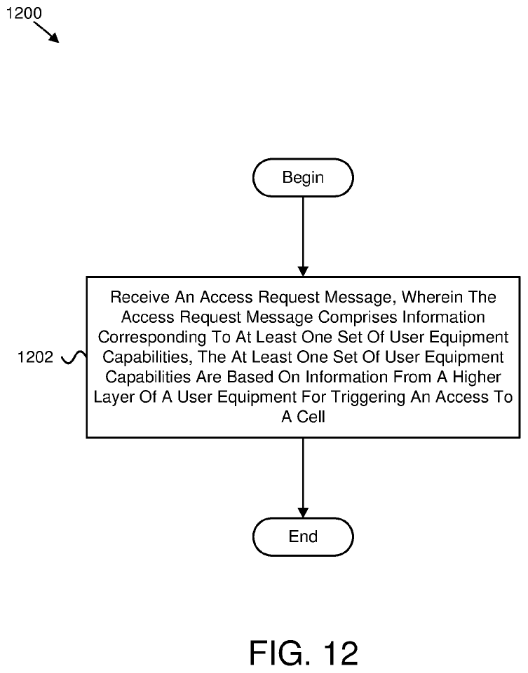

FIG. 12 is a flow chart diagram illustrating another embodiment of a method 1200 for including information indicating user equipment capabilities. In some embodiments, the method 1200 is performed by an apparatus, such as the network unit 104. In certain embodiments, the method 1200 may be performed by a processor executing program code, for example, a microcontroller, a microprocessor, a CPU, a GPU, an auxiliary processing unit, a FPGA, or the like.

In various embodiments, the method 1200 includes receiving 1202, at a network device, an access request message. The access request message includes information corresponding to at least one set of user equipment capabilities, and the at least one set of user equipment capabilities are based on information from a higher layer of a user equipment for triggering an access to a cell.

In certain embodiments, the method 1200 further comprises identifying, based on a logical channel identity, that the access request message is an extended access request message, wherein the extended access request message further comprises information of a user equipment type of the user equipment, information of a full user equipment identity of the user equipment, or a combination thereof. In some embodiments, the method 1200 further comprises transmitting a configuration for subsequent communications, wherein the configuration is based on the information corresponding to the at least one set of user equipment capabilities.

In various embodiments, the configuration comprises a radio bearer configuration, a physical layer parameter configuration, or a combination thereof. In one embodiment, the user equipment comprises a device with a reduced capability.

In one embodiment, a method of a user equipment comprises: determining at least one set of user equipment capabilities; and transmitting an access request message to a network device, wherein the access request message comprises information corresponding to the at least one set of user equipment capabilities.

In certain embodiments, the access request message further comprises information corresponding to a plurality of sets of user equipment capabilities supported by the user equipment.

In some embodiments, the method further comprises receiving a configuration for subsequent communications, wherein the configuration is based on the information corresponding to the at least one set of user equipment capabilities.

In various embodiments, the configuration comprises a radio bearer configuration, a physical layer parameter configuration, or a combination thereof.

In one embodiment, the method further comprises receiving information from a higher layer of the user equipment for triggering an access to a cell, wherein determining the at least one set of user equipment capabilities comprises determining the at least one set of user equipment capabilities based on the received information from the higher layer.

In certain embodiments, the access request message further comprises information of a full user equipment identity of the user equipment.

In some embodiments, the method further comprises: receiving access barring information via a broadcast channel; and determining whether access to a cell is restricted based on the access barring information; wherein transmitting the access request message comprises transmitting the access request message in response to determining that the access to the cell is not restricted.

In various embodiments, the access barring information comprises a plurality of access barring information, and each of the plurality of access barring information corresponds to a user equipment type.

In one embodiment, the access request message further comprises information of a user equipment type of the user equipment.

In certain embodiments, the user equipment comprises a device with a reduced capability.

In one embodiment, an apparatus comprising a user equipment. The apparatus further comprises: a processor that determines at least one set of user equipment capabilities; and a transmitter that transmits an access request message to a network device, wherein the access request message comprises information corresponding to the at least one set of user equipment capabilities.

In certain embodiments, the access request message further comprises information corresponding to a plurality of sets of user equipment capabilities supported by the user equipment.

In some embodiments, the apparatus further comprises a receiver that receives a configuration for subsequent communications, wherein the configuration is based on the information corresponding to the at least one set of user equipment capabilities.

In various embodiments, the configuration comprises a radio bearer configuration, a physical layer parameter configuration, or a combination thereof.

In one embodiment, the apparatus further comprises a receiver that receives information from a higher layer of the user equipment for triggering an access to a cell, wherein determining the at least one set of user equipment capabilities comprises determining the at least one set of user equipment capabilities based on the received information from the higher layer.

In certain embodiments, the access request message further comprises information of a full user equipment identity of the user equipment.

In some embodiments, the apparatus further comprises a receiver, wherein: the receiver receives access barring information via a broadcast channel; the processor determines whether access to a cell is restricted based on the access barring information; and the transmitter transmitting the access request message comprises the transmitter transmitting the access request message in response to determining that the access to the cell is not restricted.

In various embodiments, the access barring information comprises a plurality of access barring information, and each of the plurality of access barring information corresponds to a user equipment type.

In one embodiment, the access request message further comprises information of a user equipment type of the user equipment.

In certain embodiments, the user equipment comprises a device with a reduced capability.

In one embodiment, a method of a network device comprises: receiving an access request message, wherein the access request message comprises information corresponding to at least one set of user equipment capabilities, and the at least one set of user equipment capabilities are based on information from a higher layer of a user equipment for triggering an access to a cell.

In certain embodiments, the method further comprises identifying, based on a logical channel identity, that the access request message is an extended access request message, wherein the extended access request message further comprises information of a user equipment type of the user equipment, information of a full user equipment identity of the user equipment, or a combination thereof.

In some embodiments, the method further comprises transmitting a configuration for subsequent communications, wherein the configuration is based on the information corresponding to the at least one set of user equipment capabilities.

In various embodiments, the configuration comprises a radio bearer configuration, a physical layer parameter configuration, or a combination thereof.

In one embodiment, the user equipment comprises a device with a reduced capability.

In one embodiment, an apparatus comprises a network device. The apparatus further comprises: a receiver that receives an access request message, wherein the access request message comprises information corresponding to at least one set of user equipment capabilities, and the at least one set of user equipment capabilities are based on information from a higher layer of a user equipment for triggering an access to a cell.

In certain embodiments, the apparatus further comprises a processor that identifies, based on a logical channel identity, that the access request message is an extended access request message, wherein the extended access request message further comprises information of a user equipment type of the user equipment, information of a full user equipment identity of the user equipment, or a combination thereof.

In some embodiments, the apparatus further comprises a transmitter that transmits a configuration for subsequent communications, wherein the configuration is based on the information corresponding to the at least one set of user equipment capabilities.

In various embodiments, the configuration comprises a radio bearer configuration, a physical layer parameter configuration, or a combination thereof.

In one embodiment, the user equipment comprises a device with a reduced capability.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method of a user equipment, the method comprising:
determining at least one set of user equipment capabilities; and
transmitting an access request message to a network device, wherein the access request message comprises information corresponding to the at least one set of user equipment capabilities.

2. The method of claim 1, further comprising receiving a configuration for subsequent communications, wherein the configuration is based on the information corresponding to the at least one set of user equipment capabilities.

3. The method of claim 2, wherein the configuration comprises a radio bearer configuration, a physical layer parameter configuration, or a combination thereof.

4. The method of claim 1, further comprising receiving information from a higher layer of the user equipment for triggering an access to a cell, wherein determining the at least one set of user equipment capabilities comprises determining the at least one set of user equipment capabilities based on the received information from the higher layer.

5. The method of claim 1, wherein the access request message further comprises information of a full user equipment identity of the user equipment, information of a user equipment type of the user equipment, or a combination thereof.

6. The method of claim 1, further comprising:
receiving access barring information via a broadcast channel; and
determining whether access to a cell is restricted based on the access barring information;
wherein transmitting the access request message comprises transmitting the access request message in response to determining that the access to the cell is not restricted; and
wherein the access barring information comprises a plurality of access barring information, and each of the plurality of access barring information corresponds to a user equipment type.

7. The method of claim 18, wherein the user equipment comprises a device with a reduced capability.

8. An apparatus comprising:
a processor; and
a memory coupled to the processor, the memory comprising instructions executable by the processor to cause the apparatus to:
determine at least one set of user equipment capabilities; and
transmit an access request message to a network device, wherein the access request message comprises information corresponding to the at least one set of user equipment capabilities.

9. The apparatus of claim 8, wherein the instructions are further executable by the processor to cause the apparatus to receive a configuration for subsequent communications, wherein the configuration is based on the information corresponding to the at least one set of user equipment capabilities.

10. The apparatus of claim 8, wherein the instructions are further executable by the processor to cause the apparatus to receive information from a higher layer of the user equipment for triggering an access to a cell, and determine the at least one set of user equipment capabilities based on the received information from the higher layer.

11. The apparatus of claim 8, wherein the access request message further comprises information of a full user equipment identity of the user equipment, information of a user equipment type of the user equipment, or a combination thereof.

12. A method of a network device, the method comprising:
receiving an access request message, wherein the access request message comprises information corresponding to at least one set of user equipment capabilities, and the at least one set of user equipment capabilities are based on information from a higher layer of a user equipment for triggering an access to a cell.

13. The method of claim 12, further comprising identifying, based on a logical channel identity, that the access request message is an extended access request message, wherein the extended access request message further comprises information of a user equipment type of the user equipment, information of a full user equipment identity of the user equipment, or a combination thereof.

14. The method of claim 12, further comprising transmitting a configuration for subsequent communications, wherein the configuration is based on the information corresponding to the at least one set of user equipment capabilities.

15. The method of claim 14, wherein the configuration comprises a radio bearer configuration, a physical layer parameter configuration, or a combination thereof.

16. The method of claim 1, wherein the access request message further comprises information corresponding to a plurality of sets of user equipment capabilities supported by the user equipment.

17. The method of claim 6, wherein the access barring information comprises a plurality of access barring information, and each of the plurality of access barring information corresponds to a user equipment type.

18. The method of claim 1, wherein the access request message further comprises information of a user equipment type of the user equipment.

19. The apparatus of claim 8, wherein the access request message further comprises information corresponding to a plurality of sets of user equipment capabilities supported by the user equipment.

20. The apparatus of claim 8, wherein the access request message further comprises information of a user equipment type of the user equipment.
